(19) United States
(12) Patent Application Publication
(10) Pub. No.: US 2016/0283500 A1
(43) Pub. Date: Sep. 29, 2016

(54) RECOMMENDING CONNECTIONS IN A SOCIAL NETWORK SYSTEM

(71) Applicant: International Business Machines Corporation, Armonk, NY (US)

(72) Inventors: Zheng Han, Beijing (CN); Long Li, Beijing (CN); Qiang Ma, Beijing (CN); Yan M. Sun, Beijing (CN); Li Zhang, Beijing (CN)

(21) Appl. No.: 15/056,308

(22) Filed: Feb. 29, 2016

Related U.S. Application Data
(63) Continuation of application No. 14/671,028, filed on Mar. 27, 2015.

(51) Int. Cl. G06F 17/30; H04L 29/08

(52) U.S. Cl. CPC G06F 17/3097; H04L 67/306; H04L 67/12; G06F 17/30867

(57) ABSTRACT

In an approach for recommending one or more connections in a social network system, a computer retrieves user profile information for a user of a social network system, and determines, based, at least in part, on the user profile information, a stage for the user, wherein the stage represents a social maturity level of the user in the social network system. The computer then determines, based, at least in part, on the user profile information and the stage, whether at least one connection is identified for the user in the social network system. Responsive to determining at least one connection is identified for the user, the computer recommends the at least one connection to the user.

### BACKGROUND OF THE INVENTION

The present invention relates generally to the field of social network systems, and more particularly to recommending one or more connections in a social network system.

Enterprise social network services are widely used to develop and maintain both personal and professional relationships. In such a social network system, each user maintains a profile page and can share items and post updates to a personal page. The user can invite other users to join his or her network, and usually the social network system can recommend other users to connect with based on whether the user may know the other user. For example, the social network system may determine that the user and a second user are connected to a certain number of same people, and recommend that the user and the second user should be connected based on the number of same people in common. Another social network system may recommend users based on similar location or business unit. However, a user may not always want to connect with those nearby, or with those who may have connections in common, but the user may want to connect with users that share a similar interest or hobby.

### SUMMARY

Embodiments of the present invention disclose a method, a computer program product, and a computer system for recommending one or more connections in a social network system. In the method, a computer retrieves user profile information for a user of a social network system, and determines, based, at least in part, on the user profile information, a stage for the user, wherein the stage represents a social maturity level of the user in the social network system. The computer then determines, based, at least in part, on the user profile information and the stage, whether at least one connection is identified for the user in the social network system. Responsive to determining at least one connection is identified for the user, the computer recommends the at least one connection to the user.

### BRIEF DESCRIPTION OF THE DRAWINGS

FIG. 1 is a functional block diagram illustrating a data processing environment, in accordance with an embodiment of the present invention;

FIG. 2 is a flowchart depicting operational steps of a recommendation module, for recommending one or more connections in a social network system, in accordance with an embodiment of the present invention;

FIG. 3 is a block diagram of an exemplary process flow of operation of the recommendation module of FIG. 2, in accordance with an embodiment of the present invention; and

FIG. 4 is a block diagram of components of a data processing system, such as the server computing device of FIG. 1, in accordance with an embodiment of the present invention.

### DETAILED DESCRIPTION

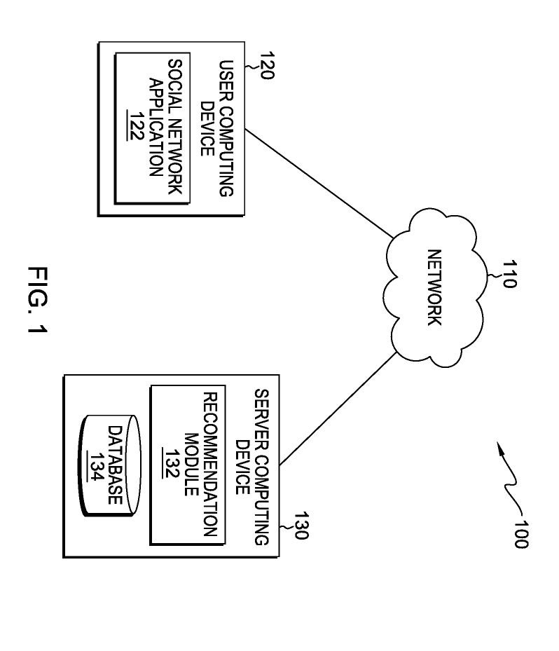

The present invention will now be described in detail with reference to the Figures. FIG. 1 is a functional block diagram illustrating a data processing environment, generally designated 100, in accordance with one embodiment of the present invention. FIG. 1 provides only an illustration of one implementation and does not imply any limitations with regard to the environments in which different embodiments may be made by those skilled in the art without departing from the scope of the invention as recited by the claims.

Data processing environment 100 includes user computing device 120 and server computing device 130, interconnected via network 110. Network 110 can be, for example, a telecommunications network, a local area network (LAN), a wide area network (WAN), such as the Internet, or a combination of the three, and can include wired, wireless, or fiber optic connections. Network 110 may include one or more wired and/or wireless networks that are capable of receiving and transmitting data, voice, and/or video signals, including multimedia signals. In general, network 110 can be any combination of connections and protocols that will support communications between user computing device 120, server computing device 130, and other computing devices (not shown) within data processing environment 100.

In various embodiments, user computing device 120 can be a laptop computer, a tablet computer, a smartphone, or any programmable electronic device capable of communicating with server computing device 130 via network 110, and with various components and devices (not shown) within data processing environment 100. User computing device 120 may be a wearable computer. Wearable computers are electronic devices that may be worn by the bearer under, with, or on top of clothing, as well as in glasses, hats, wigs, or other accessories, and are capable of receiving, processing, storing, sending, and displaying data. In general, user computing device 120 represents any programmable electronic device capable of executing machine readable program instructions and communicating with other computing devices via a network, such as network 110. User computing device 120 includes social network application 122.

Social network application 122 is a software application providing a platform to a user to build social networks and social relationships among people who share interests, activities, backgrounds, or real-life connections. Social network application 122 can be a web-based service that allows a user to create a public profile, create a list of other users of a social network with whom to share connections, and to interact with the other users. A social network connection is a relationship between two users of a social network system, the connection allowing the users to share ideas, interests, and other items. The user created public profile may contain profile information such as identifying information, current activities, background information, and interests. Social network application 122 is a client-side application operating on user computing device 120, and allowing a user of user computing device 120 access to other users of a social network system via network 110.

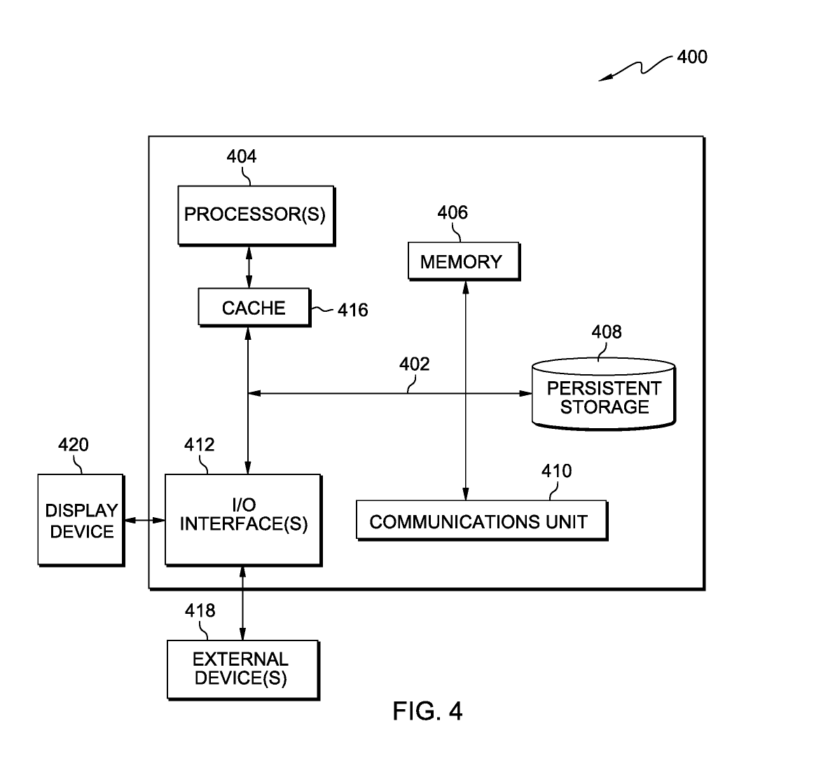

In various embodiments, server computing device 130 can be a standalone computing device, management server, a web server, a mobile computing device, or any other electronic device or computing system capable of receiving, sending, and processing data. In other embodiments, server computing device 130 can represent a server computing system utilizing multiple computers as a server system. In another embodiment, server computing device can be a laptop computer, a tablet computer, a netbook computer, a personal computer, a desktop computer, or any programmable electronic device capable of communicating with other computing devices (not shown) within data processing environment 100 via network 110. In another embodiment, server computing device 130 represents a computing system utilizing clustered computers and components (e.g., database server computers, application server computers, etc.) that act as a single pool of seamless resources when accessed within data processing environment 100. In one embodiment, server computing device 130 is an application server providing shared server functions to software applications on client server networks, such as a social network application. Server computing device 130 includes recommendation module 132 and database 134. In various embodiments, each of the program and database included on server computing device 130 may be located elsewhere within data processing environment 100 with access to server computing device 130 via network 110. Server computing device 130 may include internal and external hardware components, as depicted and described with respect to computer system 400 in FIG. 4.

Recommendation module 132 evaluates a user's profile and other social network information to determine a social maturity level, or stage, of the user, the social maturity stage indicating whether the user is a new user, for example, one with few, if any, connections, an intermediate user, for example, one with many connections but each in the same business unit or location, or an experienced user, for example, one with many connections across business unit, country, age range, etc. Based on the determined social maturity value and user stage, recommendation module 132 determines a mining engine with which to evaluate the user. Each mining engine utilized by recommendation module 132 retrieves a plurality of information, for example, a profile mining engine retrieves structured, basic, profile information of the user. Based on the mining engine evaluation, recommendation module 132 identifies one or more social network connections to the user. In an embodiment, recommendation module 132 is a plugin or an add-on to social network application 122.

Database 134 resides on server computing device 130. A database is an organized collection of data. Database 134 can be implemented with any type of storage device capable of storing data that can be accessed and utilized by server computing device 130, such as a database server, a hard disk drive, or a flash memory. In other embodiments, database 134 can represent multiple storage devices within data processing environment 100 or within server computing device 130. Database 134 stores information for use with recommendation module 132, for example, user profile information, including user identifying information, and various models trained using machine learning methods for predicting a user's interests. In an embodiment, database 134 is a database providing a mechanism for storage and retrieval of data that is modeled in means other than the tabular relations used in relational databases, such as a NoSQL database.

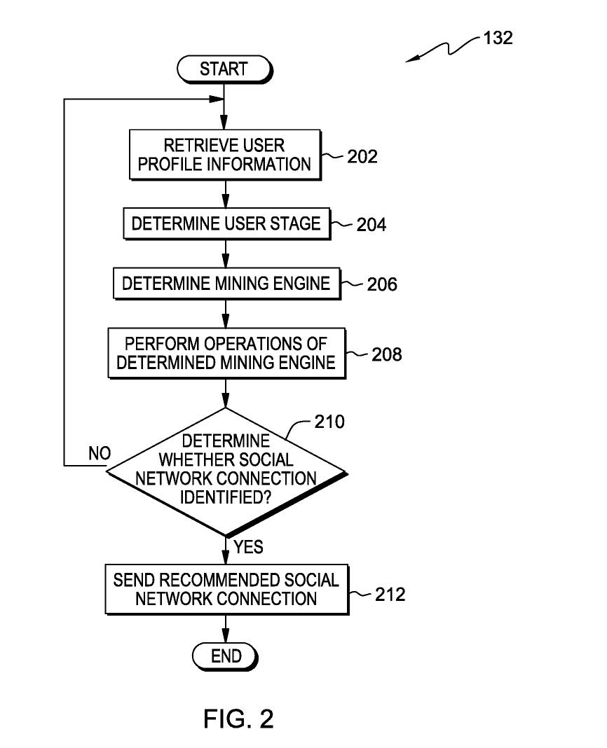

FIG. 2 is a flowchart depicting operational steps of recommendation module 132 for recommending one or more connections in a social network system, in accordance with an embodiment of the present invention.

Recommendation module 132 retrieves user profile information (202). In an embodiment, recommendation module 132 is initialized at user login to a social network system, such as via a login to social network application 122. In another embodiment, a user may select a personalized setting in social network application 122 to execute recommendation module 132 at a particular time, or at any time when the user opts to execute recommendation module 132. When initialized, recommendation module 132 retrieves user profile information from the user's profile or a user's personal page. In various embodiments, user profile information may include, for example, user identifying information, such as name, location, career position, and company or business unit, user status updates, user comments, including either comments on user shared items or comments on items shared by other users, and user shared items or photos. User shared items may include, for example, news articles, blog posts, website links, restaurant or theater reviews, and other such items. User profile information may include user interests or activities, or information on the user's connections, for example, who the user is connected to and to how many other users the user is connected. In an embodiment, recommendation module 132 retrieves user profile information and stores the information in a database, such as database 134.

Recommendation module 132 determines a user stage (204). Recommendation module 132 evaluates the retrieved user profile information to determine to which stage the user belongs, where the user stage may also be referred to as the user's social maturity. In an embodiment, recommendation module 132 groups the user into one of three stages based on a number of current connections, and a location of each current connection, the location either a physical location or a business organization location, or status. The first stage includes new or inexperienced users of the social network system. A user in the first stage may have few, if any, connections. The second stage may include a user with several, or many, connections (i.e., more than a first stage user), but the connections are limited to those users in the same business unit, same team, or same location. The third stage includes those users with many connections across the same location and same business unit, but also connections from different business units and countries. In an embodiment, recommendation module 132 determines a user stage using a pre-determined threshold number of connections for each stage, or a pre-determined threshold number of connections per location for each stage.

In an embodiment, recommendation module 132 evaluates a user's stage (i.e., the user social maturity value, “SM”) based on three factors and a social maturity evaluation formula, Formula (1) in Table 1 below. The first factor is a user's social activity degree, “SAD”, represented by Formula (2) in Table 1, which is a measure of the user's activity in the social network system, and can be determined based on, for example, a user status update number, “SUN”, a forwarded tweets numbers (e.g., updates shared by the user), “FTN”, and a comments number, “CN”. The SAD value may be determined for a period of time, such as the previous month of activity, and then normalized to a value between 0 and 1.

The second factor is a user's network diversity degree, “NDD”, and is a measure of the diversified locations of the user's connections, which can be determined based on a proportion of a user's friends worldwide, “WFN”, to the user's total friend number, “TFN”. The user NDD can be calculated based on Formula (3) in Table 1 below. The third factor is a profile complete degree, “PCD”, and can be determined by a comparison between a completed user profile information, “CPI”, and the total profile information, “TPI” in the social network system, i.e., a measure of a comparison of the completeness of the user's profile with those profiles of other users. The PCD value can be calculated based on Formula (4) below.

In Formula (1) below, the corresponding weight parameters, α, β, and γ, sum to equal 1. In various embodiments, the weight parameters are pre-determined values, and may be determined by an administrator or other manager of the social network system. In one embodiment, α is greater than β and γ, for example, α=0.5 and β, γ=0.25. In an embodiment, the weight parameters can be determined based on a decision by an administrator that the social activity factor is more important than the network diversity degree, or that the network diversity degree and the profile complete degree are of equal importance, or of varying importance.

TABLE 1
Social Maturity Evaluation Formula

| | |
|---|---|
| SM = α * SAD + β * NDD + γ * PCD | (1) |
| SAD = SUN + FTN + CN | (2) |
| NDD = WFN/TFN | (3) |
| PCD = CPI/TPI | (4) |

If the SM value is lower than a first pre-determined threshold value, then recommendation module 132 identifies the user as belonging to, or being associated with, the first stage. If the SM value is lower than a second pre-determined threshold value, then recommendation module 132 identifies the user as belonging to, or being associated with, the second stage. In an embodiment, if the SM value is lower than the second pre-determined threshold value, but higher than the first pre-determined threshold value, then recommendation module 132 identifies the second stage for the user. If the SM value is lower than a third pre-determined threshold value, then recommendation module 132 identifies the user as belonging to, or being associated with, the third stage. In an embodiment, if the SM value is lower than the third pre-determined threshold value, but higher than the second pre-determined threshold value, then recommendation module 132 identifies the third stage for the user. In an embodiment, if the SM value is higher than each of the pre-determined thresholds, then the user does not need social network connection recommendations, and recommendation module 132 ends processing. In various embodiments, each of the first, second, and third pre-determined threshold values can be set by a user at set up of recommendation module 132, by a social network system administrator, or by another administrator or manager with access to set up of recommendation module 132.

Recommendation module 132 determines a mining engine (206), for each stage, for evaluating a user. In embodiments of the present invention, recommendation module 132 identifies a profile mining engine for users in the first stage, such profile mining engine evaluating structured user profile information from the user's profile, and determining other users with matching, or similar, profile information, for example, business unit, team, organization, etc. For users in the second stage, recommendation module 132 identifies a network mining engine, the network mining engine retrieving one or more connections with connections in common with the user, using, for example, a contact list of the user. Recommendation module 132 identifies a text mining engine for users in the third stage, which retrieves text from other users and determines other users with similar interests and activities as the user.

In an embodiment, recommendation module 132 determines keywords in the user's profile information, and may tag each keyword as associated with a category. For example, a “name category” can include the user's name, while an “interest category” may include user entered interests from the user profile, or may include keywords identified in a status update, such as a sport or musician. Keywords and any associated tags can be stored in database 134, and may be used with any of the mining engines.

Recommendation module 132 performs operations according to the determined mining engine (208). In various embodiments, each mining engine identified is used to extract information from the retrieved user profile information, in order to determine one or more connections for the user. In an embodiment, the profile mining engine evaluates structured user profile information from the user's profile, and determines other users with matching, or similar, profile information. The structured profile information can be stored in database 134. In an embodiment, the network mining engine retrieves potential connections via the user's contact list, using one of a plurality of network mining methods, such as collaborative filtering, to find a second user with a maximum connections in common with the user. In an embodiment, the text mining engine identified for users in the third stage retrieves and collects a corpus of data from other users of the social network system, including, for example, status updates, user comments, user shared items, and communities in which the other user may be involved. The text mining engine uses the data with supervised learning methods to train a model, for example, a decision tree, a deep neural network (DNN), etc. Recommendation module 132, via the text mining engine, uses the model to predict a user's interests, given the user's information, where the model is based on a plurality of other users' data. Processes may be performed on the model to minimize the training error, for example, a least square method process. Recommendation module 132 uses the predicted interest to recommend connections with the same interest.

Recommendation module 132 determines whether at least one social network connection is identified (decision step 210). If at least one social network connection is identified (decision step 210, “yes” branch), recommendation module 132 sends the at least one recommended social network connection to the user (212). Recommendation module 132, when the recommended connection is identified, sends the recommendation to the user, for example, as a message or alert in social network application 122. The recommendation may include a name of another user, or some other identifying information. In various embodiments, recommendation module 132 includes a list of reasons why the connection is recommended, for example, similar interests, connections in common, or similar location. In some embodiments, recommendation module 132 may identify one or more social network connections for the user, and may determine to send one, or several, of the identified connections. Recommendation module 132 may rank the one or more connections, based on various criteria, including, for example, a closeness in location, a number of connections in common over a threshold number, or a strong similarity in interests versus a lower similarity in interests.

If a social network connection is not identified (decision step 210, “no” branch), recommendation module 132 returns to retrieve further, additional user profile information (202). In various embodiments, recommendation module 132 returns to retrieve user profile information updates, including, for example, status updates or shared items. In an embodiment, recommendation module 132 ends processing if no social network connections are identified.

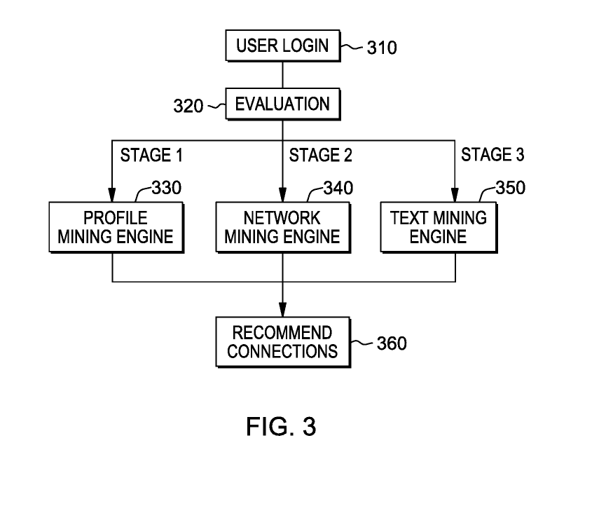

FIG. 3 is a block diagram of an exemplary process flow of operation of recommendation module 132, in accordance with an embodiment of the present invention.

Diagram 300 depicts an overall process flow of operations performed by recommendation module 132 to recommend connections to social network system users based on varying social needs. Block 310 represents initialization of recommendation module 132 at user login, and block 320 depicts the evaluating steps performed by recommendation module 132 to determine what stage each user belongs to, discussed above with reference to 204. Blocks 330, 340, and 350 depict each user stage, or social maturity level, and the associated mining engine used to recommend connections for users in the corresponding stage. For example, block 330 depicts a profile mining engine for a user in stage 1, block 340 depicts a network mining engine for a user in stage 2, and block 350 depicts a text mining engine for a user in stage 3. Block 360 depicts results of operations at blocks 330, 340, and 350, such that connections are recommended to the user.

FIG. 4 depicts a block diagram of components of a computer system 400, which is an example of a system such as server computing device 130 of FIG. 1, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computer system 400 includes computer processors(s) 404, cache 416, memory 406, persistent storage 408, communications unit 410, input/output (I/O) interface(s) 412, and communications fabric 402. Communications fabric 402 provides communications between cache 416, memory 406, persistent storage 408, communications unit 410, and I/O interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 416 is a memory that enhances the performance of processor(s) 404 by storing recently accessed data, and data near recently accessed data, from memory 406.

Program instructions and data used to practice embodiments of the present invention can be stored in persistent storage 408 for execution and/or access by one or more of the respective processor(s) 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices within data processing environment 100. In these examples, communications unit 410 includes one or more network interface cards. Communications unit 410 may provide communications through the use of either or both physical and wireless communications links. Program instructions and data used to practice embodiments of the present invention may be downloaded to persistent storage 408 through communications unit 410.

I/O interface(s) 412 allows for input and output of data with other devices that may be connected to server computing device 130. For example, I/O interface(s) 412 may provide a connection to external device(s) 418 such as a keyboard, a keypad, a touch screen, and/or some other suitable input device. External device(s) 418 can also include portable computer readable storage media such as, for example, thumb drives, portable optical or magnetic disks, and memory cards. Software and data used to practice embodiments of the present invention, can be stored on such portable computer readable storage media and can be loaded onto persistent storage 408 via I/O interface(s) 412. I/O interface(s) 412 also connect to a display 420. Display 420 provides a mechanism to display data to a user and may be, for example, a computer monitor or an incorporated display screen, such as is used, for example, in tablet computers and smart phones.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for recommending one or more connections in a social network system, the method comprising:
retrieving, by one or more computer processors, user profile information for a user of a social network system;
determining, by one or more computer processors, based, at least in part, on the user profile information, a stage for the user, wherein the stage represents a social maturity level of the user in the social network system;
determining, by one or more computer processors, based, at least in part, on the user profile information and the stage, whether at least one connection is identified for the user in the social network system; and
responsive to determining at least one connection is identified for the user, recommending, by one or more computer processors, the at least one connection to the user.

2. The method of claim 1, wherein determining, based, at least in part, on the user profile information, a stage for the user further comprises:
determining, by one or more computer processors, a number of connections of the user in the social network system; and
determining, by one or more computer processors, a location of each of the number of connections.

3. The method of claim 1, wherein determining, based, at least in part, on the user profile information and the stage, whether at least one connection is identified for the user in the social network system further comprises:
identifying, by one or more computer processors, a mining engine for the stage, wherein the mining engine extracts information from at least the user profile information.

4. The method of claim 1, wherein responsive to determining at least one connection is not identified for the user, retrieving, by one or more computer processors, additional user profile information.

5. The method of claim 1, wherein determining, based, at least in part, on the user profile information, a stage for the user further comprises:
determining, by one or more computer processors, a first factor, a second factor, and a third factor, wherein the first factor is a measure of activity of the user in the social network system, the second factor is a measure of diversity in location of each of a plurality of user connections, the third factor is a measure of completeness of the user profile as compared to profiles of a plurality of other users; and
determining, by one or more computer processors, based, at least in part, on the first factor, the second factor, and the third factor, a social maturity value for the user.

6. The method of claim 5, further comprising:
determining, by one or more computer processors, whether the social maturity value for the user is below a first pre-determined threshold value; and
responsive to determining the social maturity value for the user is below the first pre-determined threshold value, determining, by one or more computer processors, the user as belonging to a first stage.

7. The method of claim 5, further comprising:
determining, by one or more computer processors, whether the social maturity value for the user is below a second pre-determined threshold value; and
responsive to determining the social maturity value for the user is below the second pre-determined threshold value, determining, by one or more computer processors, the user as belonging to a second stage.

8. The method of claim 1, wherein the user profile information includes at least one of: a user name, a location, a career position, a company, a business unit, one or more user status updates, one or more user comments, and one or more user shared items.
